(19) United States
(12) Patent Application Publication
(10) Pub. No.: US 2011/0225067 A1
(43) Pub. Date: Sep. 15, 2011

(54) FRAUD PREVENTION USING CUSTOMER AND AGENT FACING DEVICES

(75) Inventor: Kimberly Dunwoody, Parker, CO (US)

(73) Assignee: The Western Union Company, Englewood, CO (US)

(21) Appl. No.: 12/723,345

(22) Filed: Mar. 12, 2010

(51) Int. Cl. G06Q 20/00; G06Q 30/00; H04N 7/18

(52) U.S. Cl. 705/27.1; 705/34; 705/40; 705/44; 348/61; 348/E07.091

(57) ABSTRACT

A method of restricting the disbursement of funds in a money transfer, the method occurring at a money transfer system, the method comprising: receiving a money transfer request from a requester including information about a pending transaction between the requester and a provider; providing the money transfer request to a sender, the money transfer request informing the sender of the pending transaction and requesting that the sender provide funds for the pending transaction; receiving an acceptance from the sender to perform the money transfer, the acceptance restricting the use of the funds to pay for the pending transaction; and executing a money transfer from the sender to the provider such that the money is transferred without being accessible to the requester.

### BACKGROUND OF THE INVENTION

This invention relates generally to financial transfers. More specifically, the invention relates to financial transfers utilizing a method to restrict how the funds of a money transfer are used.

Money transfers are a common way to transfer funds between persons and/or entities. Money transfers are often performed through the use of a money transfer organization with multiple branch offices and agents to assist in the money transfer process. A common reason to transfer funds is to assist a person or entity in paying a bill for a good and/or service. A potential problem with a money transfer is that the transferor of the money has minimal assurance that the transferred funds will be used to pay the bill or purchase a good and/or service for which the money transfer was specified. Often the transferor must rely on the transferee's assurance that the bill is paid or the good is purchased. In some instances the funds may be used on something other than to pay the bill or purchase the good and/or service thereby frustrating the initial purpose of the money transfer. Thus, there is a need to provide a way for a money transfer process to be performed that would provide a transferor with assurance that the transferred funds will be used for their intended purpose.

### BRIEF SUMMARY OF THE INVENTION

The systems and methods described include a money transfer system configured to receive a money transfer request from a requester and provide this information to a sender. The money transfer request can include information about a transaction pending between the requester and a provider of goods and/or services, such as a merchant, utility company, etc., and can also include a request that the sender provide funds for the pending transaction. The money transfer system is further configured to receive an acceptance from the sender in which the sender agrees to fund the pending transaction and in which the sender places one or more restrictions on the money transfer so that the funds may be restricted to paying for the pending transaction. The money transfer system then executes the money transfer in accordance with the sender's restrictions and the funds are transferred from the sender to the provider without being accessible to the requester in a way other than in accordance with the restrictions.

An exemplary embodiment of the invention includes a method of restricting the disbursement of funds in a money transfer. The method occurs at a money transfer system that may be used by a money transfer facilitator or other entity that provides financial services. The method may include receiving a money transfer request from a requester such as person in need of funds to pay for a pending transaction between the requestor and another person and/or entity. The transaction may be pending payment of a bill for a product and/or service. The money transfer request may include information about the pending transaction. The money transfer system may send the money transfer request to a sender (i.e. a person that is requested to provide funds for the bill). The money transfer request may inform the sender of the pending transaction and requests that the sender provide funds to pay for the pending transaction. The money transfer system may receive a sender's acceptance to perform a money transfer where the money transfer provides funds to pay for the pending transaction. The acceptance may also restrict the use of the funds to paying for the pending transaction. The money transfer system may execute a money transfer from the sender to the provider (i.e. the person and/or entity that is part of the pending transaction with the requester) where the money is transferred without being accessible to the requester such as by sending the funds directly to the provider and/or to an account controlled by the provider.

The restriction received from the sender may further restrict the requester's ability to exchange and/or return a product purchased by the money transfer funds. The restriction may limit the requester's ability to exchange and/or return the product for any of the following: money, an additional product, and a service. The money transfer system may receive the restriction and, in response, establish exchange and/or return rules such that if the requester returns or attempts to exchange the product, the funds are transferred back the sender.

The method may also include the use of a transaction identifier that associates the money transfer with the provider where the transaction identifier facilitates in the provider gaining control of the transferred funds such as, for example, by identifying the provider with a money transfer facilitator. The money transfer system may send the transaction identifier to the sender and the sender may provide the transaction identifier to the provider. Subsequently, the money transfer system may receive the transaction identifier from the provider, thus facilitating in the provider gaining control of the funds.

The money transfer system may calculate one or more fees associated with the money transfer. The fees may depend on one or more of the following: the amount of funds transferred in the money transfer, any currency conversion that occurs, any transfer restrictions that are applied to the money transfer, the location that the money transfer is initiated, and the location that the money transfer is completed. The fee may be used to pay for the money transfer service and may be applied to the money transfer by the money transfer system before the money transfer is executed.

The pending transaction may include an invoice for a product and/or service or both.

The invoice may including information about how the funds are to applied to the invoice. The money transfer request may provide the sender with the invoice and the invoice may facilitate or otherwise assist the sender in deciding whether to accept to provide the funds in the money transfer.

The money transfer request may be sent by the requester and received by the money transfer system in a variety of ways including: a money transfer application made over the Internet; a photograph of the product and/or service (e.g. a utility bill) taken from a mobile device and/or camera where the photograph is sent to the money transfer system along with a message requesting that the sender provide funds to pay for the product and/or service in the photograph; a request made in person to an agent using the money transfer system where the requester provides the agent with the information about the product and/or service and where the requester further provides the agent with the request that the sender provide funds for the pending transaction, etc.

An additional exemplary embodiment of then invention includes a system for restricting the disbursement of funds in a money transfer process. The system may include a communication device that is used by a requester to send a money transfer request and may further include a money transfer device (i.e. a money transfer system) that is communicatively coupled with the communication device. The money transfer device may include a communication interface and a processor. The communication interface may be configured to receive the money transfer request from the communication device. The communication interface may be further configured to provide the money transfer request to the sender to inform the sender of the pending transaction and request that the sender provide funds for the pending transaction. The communication interface may be still further configured to receive an acceptance from the sender to perform the money transfer where the acceptance restricts the use of the funds of the money transfer for payment of the pending transaction.

The communication interface may be still further configured to receive a restriction from the sender that restricts the use of the funds to pay for the pending transaction and that further restricts the requester's ability to exchange a product purchased with the funds for any of the following: money, an additional product, and a service. The restriction may direct that the funds be transferred from the provider back to the sender upon the requester attempting to exchange the product.

The processor may be configured to execute the money transfer from the sender to the provider so that the money is transferred from the sender to the provider without being accessible to the requester in a way other than in accordance with the restriction. The processor may be further configured to calculate one or more fees associated with the money transfer. The fees may depend on any or all of the following: the amount of funds transferred in the money transfer, any currency conversion that occurs, any transfer restrictions that are applied to the money transfer, the location that the money transfer is initiated, and the location that the money transfer is completed.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a block diagram illustrating a method of restricting the disbursement of funds in a money transfer, according to one embodiment of the present invention.

FIG. 2 is a flow diagram illustrating a method of restricting the disbursement of funds in a money transfer, according to one embodiment of the present invention.

FIG. 3 is a generalized schematic diagram illustrating a computer system, in accordance with various embodiments of the invention.

FIG. 4 is a flow diagram illustrating a method of restricting the disbursement of funds in a money transfer, according to another embodiment of the present invention.

FIG. 5 is a flow diagram illustrating a method of restricting the disbursement of funds in a money transfer, according to another embodiment of the present invention.

FIG. 6 is a block diagram illustrating a system for restricting the disbursement of funds in a money transfer, which can be used in accordance with various embodiments of the invention.

### DETAILED DESCRIPTION OF THE INVENTION

Embodiments of the present invention provide systems and methods for restricting the disbursement of funds in a money transfer process. Exemplary embodiments provide a money transfer system that a sender of funds may use to restrict how transferred funds are used by a requester or receiver of the funds. The systems and methods of the present invention include a money transfer system that is configured to receive a money transfer request from a requester and provide this information to a sender. The money transfer request can include information about a transaction that is pending between the requester and a provider of goods or services, such as a merchant, utility company, etc. The money transfer request can also include a request that the sender provide funds for the pending transaction. The money transfer system is further configured to receive an acceptance from the sender in which the sender agrees to fund the pending transaction and in which the sender places restriction on the funds so that the use of the funds may be restricted to paying for the pending transaction. The money transfer system may then execute the money transfer in accordance with the sender's restrictions and the funds are transferred from the sender to the provider without being accessible to the requester in a way other than according to the restrictions.

The money transfer system may be used by a money transfer facilitator so that the requester can interact with the money transfer facilitator and the money transfer can be performed by the money transfer system. A money transfer facilitator as used herein can include any type of institution that is involved with money and specifically any institution that is involved with money transfers or the transfer of value from one location to another. The requester as used herein can include one or more individuals or organizations that request that another person, persons, organizations, or any combination thereof provide money to pay for a transaction involving the requester. The sender as used herein can include one or more individuals or organizations toward which the requester's request is directed. The provider as used herein can include any individual or organization that provides a benefit, such as a merchant, utility company, service provider (e.g. attorney), etc.

A money transfer situation involving a need to restrict the disbursement of funds may arises in several ways. For example, a requester or receiver of the funds in a money transfer may be a minor child that has limited contractual ability. In another example, the need may be connected to a requester's poor credit rating, a requester's legal trouble, squandered funds from a past money transfer, etc. In any case, the methods described herein can be used whenever it is useful for a sender of money to control how a receiver of the money spends the transferred funds.

In addition, the methods and systems described herein can be used to restrict the transferred funds to payment or purchase of a variety of goods and/or services. For example, the transferred funds may be restricted to payment of services such as the payment of a utility bill, rent, mortgage payment, legal services, etc. The transferred fund may also be restricted to pay for certain goods such as groceries or a new fishing pole. The systems and methods can also be configured for situations involving recurring payments such as a recurring bill. For example, an account can be established so that funds are transferred monthly from a sender to a merchant or service provider. An advantage of the present invention is that an additional party can help pay for the goods or services provided by that provider. In some instances, the additional party may have a better credit rating or otherwise more funds available than the party requesting the funds.

The systems and methods of the present invention can also be configured to allow the money transfer system to receive a request in a variety of ways. For example, a request can be sent through a network (e.g. the Internet), a mobile device, a kiosk, or any other communication media or the request can be made to an agent of a money transfer facilitator. Likewise, the money transfer system can be configured to send a notification of the money transfer request to the sender in a variety of ways including those mentioned in connection with receiving the request. In an exemplary embodiment, the requester's request can be made with a mobile device, such as a phone, in which the requester takes a photograph of a product or bill with the mobile device or in which the requester scans a product and/or bill's Universal Product Code (UPC) and then sends the photograph and/or UPC information to the money transfer system with a request for the sender to provide funds for the product or bill.

Likewise, the money transfer system can be configured to receive the sender's acceptance to fund the pending transaction in a number of ways. For example, the sender's acceptance can be received through a network (e.g. the Internet), a mobile device, a kiosk, or any other communication media and/or be received by an agent of a money transfer service. The acceptance may be accompanied by one or more restrictions that instructs the money transfer system to restrict the use of the transferred funds. The money transfer system can be configured to receive the acceptance and restrictions from the sender and, in response, flag the transfer, create transfer rules, or otherwise provide a notification that the transferred funds are restricted. The money transfer can then be executed such that the flag, transfer rules, or other notification ensures that the funds are transferred in compliance with the sender's restrictions. An advantage of providing the sender control in a money transfer process may be an increase in a sender's confidence due to knowing they can control how the transferred funds are used.

The restrictions can be provided by the sender at or around the time the sender accepts the request to provide the funds or, in another embodiment, the restrictions can be provided by the sender in advance of the money transfer request and stored in a database. In such an embodiment the money transfer system could interface with the database to receive the restrictions from the database and apply them automatically upon the sender's acceptance to fund the pending transaction. In addition, restrictions could also be provided by the provider either prior to or during the money transfer or both. For example, provider restrictions may result as part of a negotiation between the requester and the provider as part of the pending transaction.

In the case of goods, the restrictions can also be used to restrict the future disposal of the goods. For example, the restrictions can be created so that if the requester attempts to return or exchange the purchased good, the money is returned to the sender through a money transfer or other process. In this manner the sender can retain control of the use of the funds beyond the money transfer process and can frustrate a requester's attempt to bypass the sender's control. Likewise, similar methods and systems can be employed in organizations where control is desired beyond an initial transaction, such as when charitable organizations are concerned about individuals or other organizations taking advantage of their charitable efforts. An advantage of providing control beyond the transaction may be in lessening the burden of giving money because the giver feels less vulnerable to being exploited.

In any of the embodiments of the present invention the money transfer system may be used by a money transfer facilitator. The money transfer facilitator may charge a fee to transact the money transfer. The fee may be paid by any one of the sender, the provider, and the requester. Furthermore, the fee may be a predetermined constant amount so that the same fee is applied to every money transfer or the fee may be a variable amount that depends on the transfer amount, any currency conversion that occurs, the transfer restrictions that are applied, the location that the transfer is initiated and/or completed, etc. In addition, the fee may be calculated by the money transfer system and provided to the sender, the provider, and/or the requester prior to or during the execution of the money transfer.

Having described embodiments of the invention generally, attention is directed to FIG. 1, which depicts an exemplary block diagram of a system for restricting the disbursement of funds in a money transfer process in accordance with an embodiment of the present invention. FIG. 1 shows a money transfer method 100 that allows a sender 108 to control the disbursement of funds in a money transfer process so that the funds are transferred from the sender 108 to the provider 106. The provider 106 can be any provider of goods and/or services such as a merchant, a utility company, a service provider (e.g. a doctor), etc.

FIG. 1 depicts a pending transaction 120 (dashed lines) between the provider 106 and a requester 104. The pending transaction 120 can include any number of relationships between the provider 106 and the requester 104. For example, the pending transaction 120 can comprise a negotiation for the sale of goods and/or services, an offer from the requester 104 to purchase goods, an existing relationship between the requester and the provider such as a utility company that provides monthly services to the requester 104, etc. The dashed line of the pending transaction 120 represents that the transaction is pending payment for goods and/or services. Thus, the transaction is incomplete because the requester 104 has not yet paid for the goods and/or services that have been rendered and/or are to be rendered by the provider 106.

FIG. 1 further depicts a money transfer system 102 that is able to interface 114 with any one of the provider, the sender, and the requester. The money transfer system 102 can interface with the provider, the sender, and the requester through the use of a variety of applications and devices including, without limitation, the Internet, a mobile device, a network including a phone network, an agent, computer software, an Interactive Voice Response (IVR) interface, etc. Likewise, the money transfer system 102 is able to receive a communication from one party, such as the requester's request, and send this information to another party, such as notifying the sender and/or the provider of the request. In some embodiments, the requester may have some interaction 124 and/or play a part in the money transfer such as the requester receiving a negotiable instrument to provide to the provider and/or providing an agreement that the money transfer be executed. Additionally, the requester 104 may interact 122 with the sender 108 such as by notifying the sender of the money transfer request. Furthermore, the money transfer system 102 is able to execute a money transfer 110 between the sender 108 and the provider 106 so that funds are transferred from the sender 108 to the provider 106 without being accessible to the requester 104 in a way other than in accordance with the restriction.

An exemplary use of the money transfer system may be to pay a utility bill. The requester may have a relationship with the sender such as parent/child or sibling relationship. The sender may feel uneasy about transferring funds because of the requester's past financial problems, but may otherwise be willing to provide the funds. Using the money transfer system, the sender can provide the funds and restrict the manner in which the funds are used. The funds may be transferred directly to the utility company such as transferring the funds to the utility companies account of providing the requester with a negotiable instrument that may only be executed by the provider.

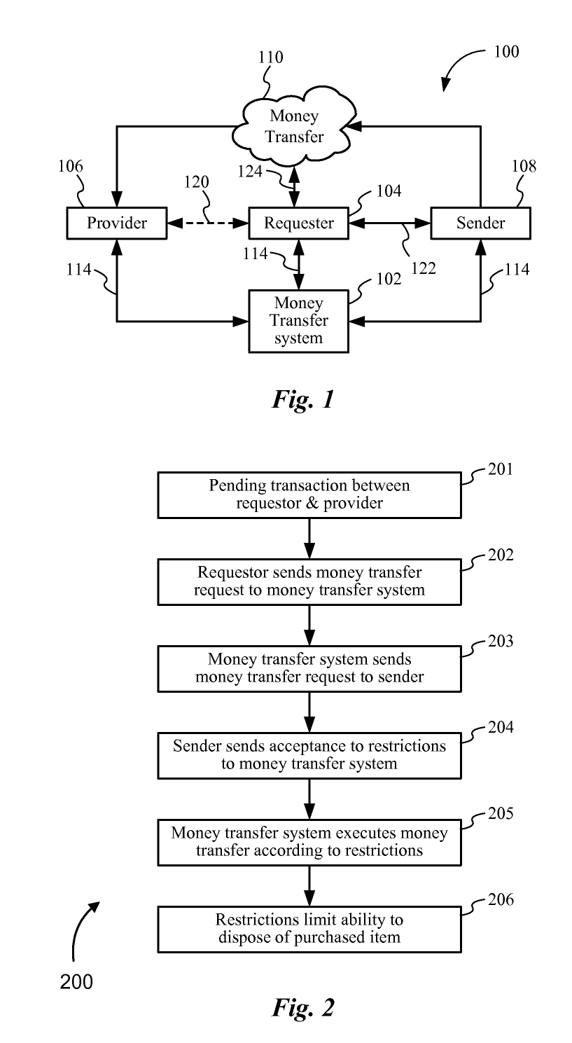

FIG. 2 depicts a method 200 for restricting the use of funds in a money transfer process that may be employed with the system of FIG. 1 or with any of the embodiments of the invention. In accordance with the method, at block 201, a pending transaction 120 such as the one previously described may exist between a requester 104 and a provider 106 for the payment of goods and/or services. At block 202, the requester may then send a money transfer request to the money transfer system 102 using a variety of applications and devices as previously described. The money transfer request can include a request that an identified sender 108 fund the existing pending transaction, for example a request to pay an existing utility bill, rent, etc. The sender 108 and the requester 104 may have a close affiliation with each other such as a parent and child or reciprocal friends or a more distant relationship.

At bock 203, the money transfer system 102 can then send the money transfer request to the sender using a variety of applications and devices as previously described. The sender can then accept or decline the request. If the sender accepts the request, the sender can then send the acceptance to the money transfer system as shown in block 204. The acceptance may be accompanied by one or more restrictions which restrict the requesters ability to use the funds for anything other than to pay for the goods and/or services. For example, the restriction may direct the money transfer system to transfer the funds directly to the control of the provider, such as to the provider's bank account. Likewise the restriction may require that a check or other negotiable instrument be made in the name of the provider so as to prevent the requester from accessing the funds. In addition to the restrictions provided by the sender, one or more restrictions may be provided by the provider as previously described.

At block 205, after the sender's acceptance has been provided to the money transfer system 102, the money transfer system 102 can then execute a money transfer in accordance with any restrictions that were provided. For example, the money transfer system can execute a money transfer so that the requester never has access to or complete control of the funds. The sender may transfer funds from a variety of sources including, without limitation, a bank account, a credit or debit card, an online financial service or bill pay service, a M-wallet or other financial application on a mobile device, a check or money order provided to an agent of a money transfer facilitator, etc. The funds may be transferred to the provider by crediting a variety of accounts associated with the provider including, without limitation, a bank account, a M-wallet or other financial application on a mobile device, an online financial service or bill pay service, by generating a check or other negotiable instrument, etc.

At block 206, the restrictions provided by the sender and/or provider can also be used to restrict the requester's ability to dispose of a product or item purchased with the transferred funds. For example, the sender may provide a restriction that would return the transferred funds back to the sender if the requester attempted to return or exchange the purchased product or item for money, a service or services, another product or products, or any combination thereof. Likewise, the restriction could return the funds back to the sender if the pending transaction failed for any reasons such as if a wrong account number was provided or an error occurred during the transfer. Thus, the restriction could provide the sender with the ability to ensure that the requester is not able to bypass or otherwise thwart the sender's control over the use of the transferred funds.

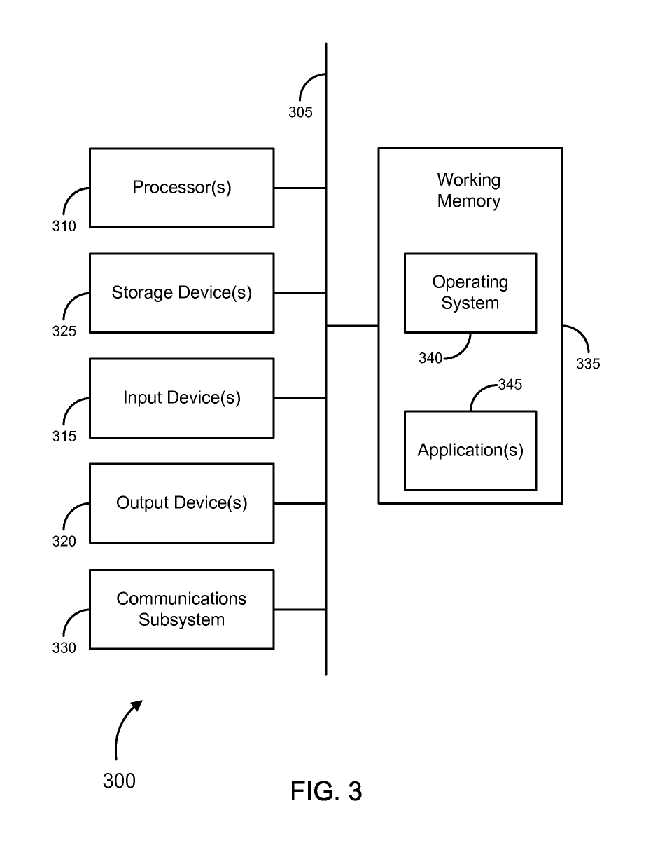

FIG. 3 provides a schematic illustration of one embodiment of a computer system 300 that can perform the methods of the invention, as described herein, and/or can function as, for example, the money transfer system 102. It should be noted that FIG. 3 is meant only to provide a generalized illustration of various components, any or all of which may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 305 (or may otherwise be in communication, as appropriate). The hardware elements can include one or more processors 310, including, without limitation, one or more general-purpose processors and/or one or more special-purpose processors (such as digital signal processing chips, graphics acceleration chips, and/or the like); one or more input devices 315, which can include, without limitation, a mouse, a keyboard and/or the like; and one or more output devices 320, which can include, without limitation, a display device, a printer and/or the like.

The computer system 300 may further include (and/or be in communication with) one or more storage devices 325, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 300 might also include a communications subsystem 330, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 330 may permit data to be exchanged with a network, and/or any other devices described herein. In many embodiments, the computer system 300 will further comprise a working memory 335, which can include a RAM or ROM device, as described above.

The computer system 300 can also comprise software elements, shown as being currently located within the working memory 335, including an operating system 340 and/or other code, such as one or more application programs 345, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 325 described above. In some cases, the storage medium might be incorporated within a computer system, such as the system 300. In other embodiments, the storage medium might be separate from a computer system (e.g., a removable medium, such as a compact disc, etc.), and or provided in an installation package, such that the storage medium can be used to program a general purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection with other computing devices such as network input/output devices may be employed.

In one aspect, the invention employs a computer system (such as the computer system 300) to perform methods of the invention. According to a set of embodiments, some or all of the procedures of such methods are performed by the computer system 300 in response to processor 310 executing one or more sequences of one or more instructions (which might be incorporated into the operating system 340 and/or other code, such as an application program 345) contained in the working memory 335. Such instructions may be read into the working memory 335 from another machine-readable medium, such as one or more of the storage device(s) 325. Merely by way of example, execution of the sequences of instructions contained in the working memory 335 might cause the processor(s) 310 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 300, various machine-readable media might be involved in providing instructions/code to processor(s) 310 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 325. Volatile media includes, without limitation, dynamic memory, such as the working memory 335. Transmission media includes coaxial cables, copper wire and fiber optics, including the wires that comprise the bus 305, as well as the various components of the communication subsystem 330 (and/or the media by which the communications subsystem 330 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 310 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 300. These signals, which might be in the form of electromagnetic signals, acoustic signals, optical signals and/or the like, are all examples of carrier waves on which instructions can be encoded, in accordance with various embodiments of the invention.

The communications subsystem 330 (and/or components thereof) generally will receive the signals, and the bus 305 then might carry the signals (and/or the data, instructions, etc., carried by the signals) to the working memory 335, from which the processor(s) 305 retrieves and executes the instructions. The instructions received by the working memory 335 may optionally be stored on a storage device 325 either before or after execution by the processor(s) 310.

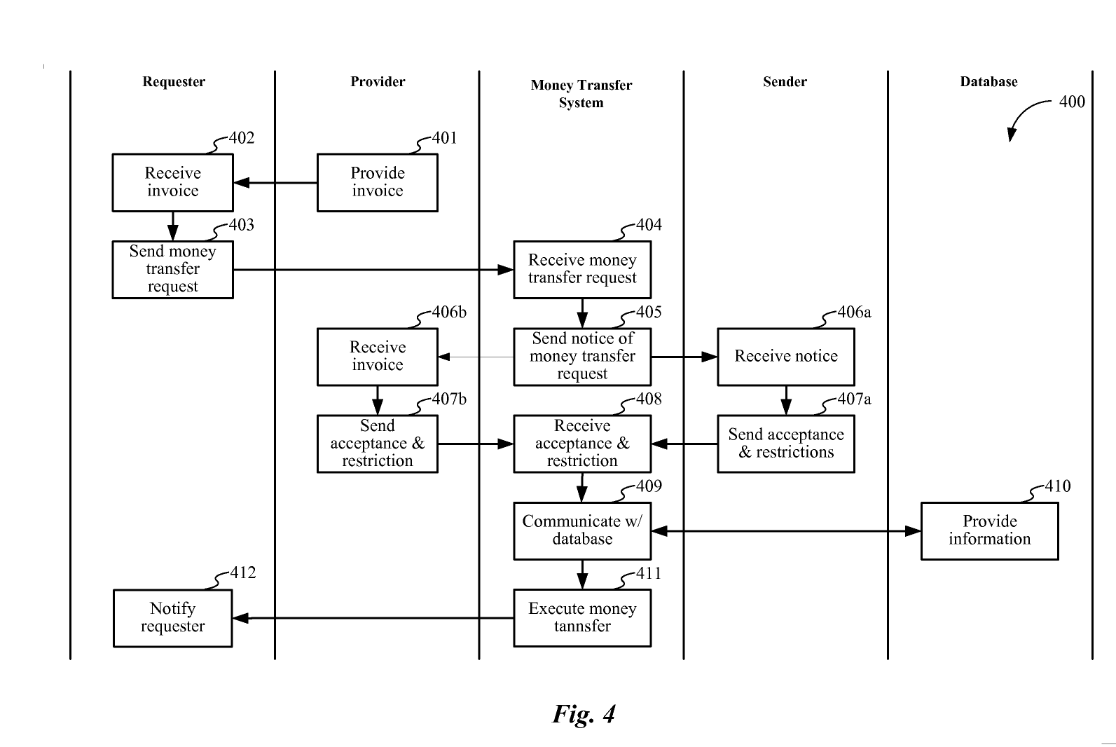

FIG. 4 depicts a flow diagram of an exemplary method of restricting the disbursement of funds in a money transfer process. The method involves a pending transaction between a provider of benefits, such as a merchant, utility company, etc., and a requester. At block 401, the provider informs the requester of an amount due for one or more products and/or services rendered. For example and without limitation, the provider can provide an invoice to the requester of the amount due for the products and/or services. Other ways to inform the requester may include providing an email, a letter, an online notification as part of a bill or online purchase, a verbal notification, or any other type of notification.

At block 402, the requester receives the invoice or other notification from the provider. The requester can then send a money transfer request to the money transfer system requesting that a sender provide funds to pay for the pending transaction as shown in block 403. The money transfer request may be sent to the money transfer system in a variety of ways including filling out a money transfer application over the Internet, taking a photograph with a mobile device or camera of the product and/or service and sending the photograph to the money transfer system along with a request that the sender provide funds to pay for the product and/or service in the photograph, making the request in person to an agent using the money transfer system, etc. In any event, the money transfer request can be received by the money transfer system using a variety of applications and devices as described previously.

At block 4040, after the money transfer system receives the money transfer request, the money transfer system then sends a notice of the money transfer request as shown in block 405. The notice of the money transfer request may include the invoice or other notification from the provider. In some embodiments, the money transfer system may send the money transfer request to the sender only. In other embodiments, the notice may be sent to any combination of the sender, the requester, the provider, and any service or institution connected therewith. For example, as specifically shown in block 405, the money transfer request can be sent to both the sender and the provider.

At block 406a, the sender receives the money transfer request from the money transfer system including the request that the sender provide funds to pay for the pending transaction. The money transfer request may also include the invoice. The invoice may specify what the funds will be used for and how the funds will be applied to pay for the corresponding products and/or services thereby facilitating in the sender's decision as to whether to accept or decline to perform the money transfer. The sender can then either accept to provide the requested funds or decline to provide the funds. If the sender declines to provide the funds, the sender's decision may be sent to all interested parties and the money transfer process aborted or canceled. Likewise, the money transfer system can be designed to abort or cancel the money transfer process if the sender does not respond to the request within a specified amount of time. If the sender accepts the request, the acceptance may be sent to the money transfer system along with any restrictions that the sender may put in place to restrict the use of the transferred funds as shown in block 407a.

Similarly, in some embodiments the provider may receive the money transfer request from the money transfer system as shown in block 406b. Such an embodiment may be advantageous where, for example, the provider is generally not aware that the requester has sent the money transfer request or where the provider wants to be informed of the money transfer process. In situations where the provider is not aware that the requester is making the money transfer request, the money transfer notice could be configured to request that both the provider and the sender agree to the money transfer. As with the sender, the provider could accept or decline to participate in the money transfer and the money transfer system could be designed to abort or cancel the process if the provider's acceptance was not received in a specified amount of time. If the provider agrees to participate in the money transfer, an acceptance along with any restrictions the provider may put on the money transfer could be sent to the money transfer system as shown in block 407b.

At block 408, after receiving any necessary acceptances and corresponding restrictions, the money transfer system could then execute or carry out the money transfer. In some embodiments, the money transfer system may optionally communicate or otherwise interact with one or more databases (shown in blocks 409 and 410) to provide and/or receive any information necessary to execute the money transfer. For example, in some embodiments the sender's financial account information, the provider's financial account information, the requester's financial account information, any restrictions, or any combination thereof may be stored on one or more databases. In such an embodiment, the money transfer system could communicate or interact with the one or more databases to withdraw funds from the sender's financial account and deposit the funds into the provider's financial account. In another embodiment, the sender's account information, the provider's account information, the requester's account information, any restrictions, or any combination thereof could be stored on a database associated with and/or maintained by the money transfer system. In such an embodiment the money transfer system could communicate or interact with this database only, thereby eliminating the need to interact with a database outside the money transfer system. Such a database would be advantageous in embodiments where the money transfer process would be repeated such as, for example, where a monthly money transfer is established for a recurring bill. Similarly, the money transfer system could communicate or interact with one or more databases to obtain one or more restrictions that restrict the use of the funds. For example, the sender's and/or provider's restrictions could be stored on a database associated with or maintained by the money transfer system thereby minimizing or eliminating the need for the sender and/or provider to provide the restrictions with the acceptance.

After the money transfer system has received all necessary acceptances and/or information including any information from any databases, the money transfer system can then execute or carry out the money transfer thereby transferring funds from the sender to the provider as shown in block 411. At block 412, the requester can be notified of the status of the money transfer. For example, the money transfer system can send a notice to the requester (e.g. email, sms message, etc.) that the money has been sent and that one or more restrictions have been applied, if any, and/or of the type of restrictions that have been applied. The funds may be transferred from a variety of the sender's sources including, without limitation, a bank account, a credit or debit card, an online financial service or bill pay service, a m-wallet or other financial application on a mobile device, a check or money order provided to an agent of a money transfer facilitator, etc. The funds may be transferred to the provider by crediting a variety of accounts associated with the provider including, without limitation, a bank account, a M-wallet or other financial application on a mobile device, an online financial service or bill pay service, or by generating a check or other negotiable instrument payable to the provider. In addition, the funds could be transferred to an escrow account whereby the provider could access the funds after completing their obligations on the pending transaction such as delivering a product involved in the pending transaction. In one embodiment, the sender may provide the funds to an agent of a money transfer facilitator located at one geographic location and the provider may pickup the funds from a different agent of the money transfer facilitator located at a different geographic location.

In addition, although not depicted in FIG. 4, the money transfer system could calculate one of more fees that a money transfer facilitator or provider would charge for transacting the money transfer and apply the fees to the money transfer before the money transfer is executed. In one embodiment, the fees could be added to the funds in the money transfer and paid by any or all of the sender, the provider, and the requester. In another embodiment the fees could be calculated at the time the requester sends the request to the money transfer system so that the requester could pay the fees up front. In still another embodiment, the fees could be calculated at any time and a separate bill for the money transfer could be sent to any or all of the sender, the provider, and the requester. Furthermore, the fee may be a predetermined constant amount so that the same fee is applied to every money transfer or the fee may be a variable amount that depends on the transfer amount, any currency conversion, any transfer restrictions that are applied, the location that the transfer is initiated and/or completed, etc.

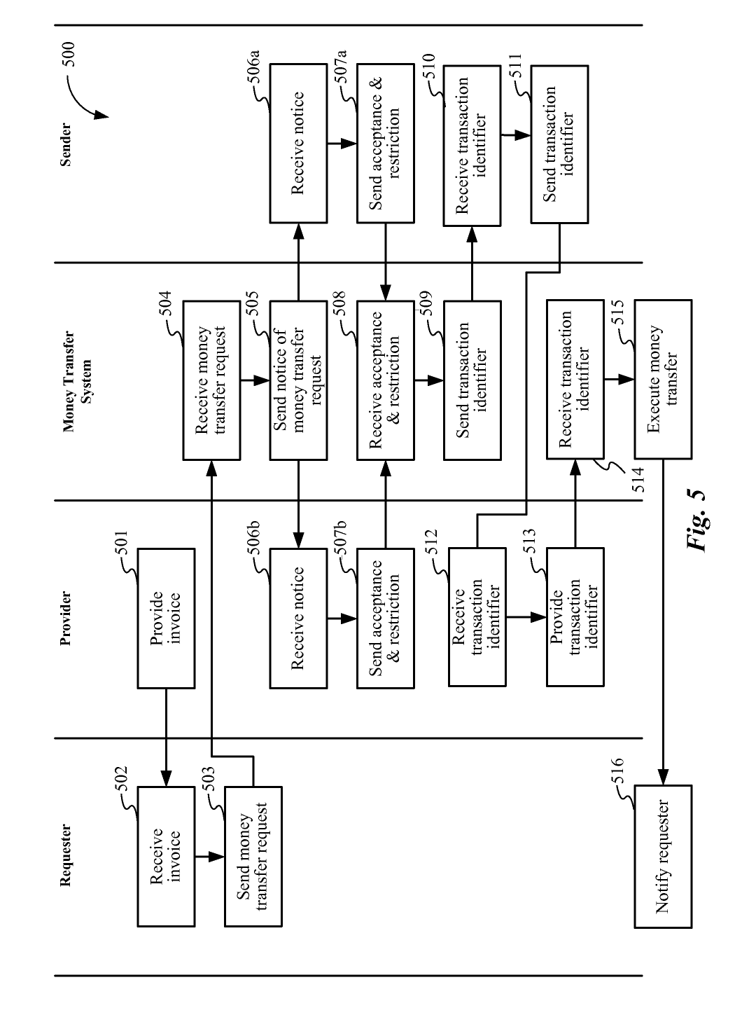

FIG. 5 depicts a flow diagram of an exemplary method according to an embodiment of the invention wherein the method includes the use of a transaction identifier to facilitate in transferring the funds from the sender to the provider. The method depicted in FIG. 5 is similar to that depicted in FIG. 4 and may include all or fewer than the steps illustrated in FIG. 4.

At block 501 the provider sends an invoice and/or other notification corresponding to a pending transaction to the requester. At block 502, the requester receives the invoice and/or other notification and thereafter sends a money transfer request to the money transfer system as shown in block 503. The request includes a request that an identified sender provide funds to pay for the pending transaction. At block 504, the money transfer system receives the requester's money transfer request and sends a notice of the money transfer request to the sender and, optionally, to the provider as shown in block 505. At blocks 506a and 506b, the sender and, optionally, the provider receive the notice of the money transfer request and in response send an acceptance and any restrictions back to the money transfer system shown in blocks 507a and 507b. At block 508, the money transfer system receives the acceptance from the sender and, optionally, the provider along with any corresponding restrictions.

At block 509, the money transfer system may then provide a transaction identifier to the sender where the transaction identifier associates the money transfer with the any or all of the following: the provider, the requester, the sender, the pending transaction, and/or any account information associated with the money transfer. For example, in one embodiment the transaction identifier may associate the money transfer with the provider only. In another embodiment, the transaction identifier may associate the money transfer with the provider, the requester, and the pending transaction. In addition, the transaction identifier may be generated by the money transfer system at any time between when the money transfer system receives the money transfer request and when the money transfer system provides the transaction identifier to the sender. The transaction identifier may also comprise any set of information including information associated with any of the sender, the provider, and the requester. For example, the transaction identifier may include any or a combination of a driver's license number, a social security number, an account number, or the like associated with the sender, the provider, and the requester.

At block 510, the sender receives the transaction identifier from the money transfer system and subsequently sends the transaction identifier to the provider at block 511. The transaction identifier may be sent to and received by the sender using a variety of applications and devices including those described previously. For example, in some embodiments the money transfer system may provide the sender with transaction identifier through an interface, such as the Internet. In other embodiments, the transaction identifier may be provided to the sender in person such as through an agent of the money transfer facilitator. Similarly, as shown in block 512, the sender may send the transaction identifier and the provider may receive the transaction identifier using any of the applications or devices described previously. For example, the sender may send the transaction identifier to the provider through an email, a voice message, a letter, in person, or the like.

Thereafter, at block 512, the provider receives the transaction identifier and subsequently provides the transaction identifier to the money transfer system at block 513. At block 514, the provider may send and the money transfer system may receive the transaction identifier using any of the applications or devices previously described. The transaction identifier associates or connects the money transfer with the provider and allows the provider to gain access to the transferred funds. In addition to providing the transaction identifier, the provider can send transfer information, such as financial account information, to the money transfer system to assist the money transfer system in transferring the funds. Alternatively, the transaction identifier may specify how to transfer the funds to the provider. Or, yet alternatively, the money transfer system can communicate or interact with a database to obtain information about how to transfer the funds to the provider.

After the transaction identifier is provided, the money transfer system may then execute the money transfer as previously described in accordance with any restrictions that were provided as shown in block 515. At block 516, the requester can be notified of the status of the money transfer such as notifying the requester that the money has been sent, that one or more restrictions have been applied, and/or of the type of restrictions that have been applied. In addition, the restrictions can be created to restrict the requester's ability to dispose of or exchange the purchased item as previously described. Likewise, the money transfer system can calculate a fee that a money transfer facilitator would charge for the money transfer and can apply that fee to the money transfer or otherwise obtain the fee from one of the parties to the money transfer transaction.

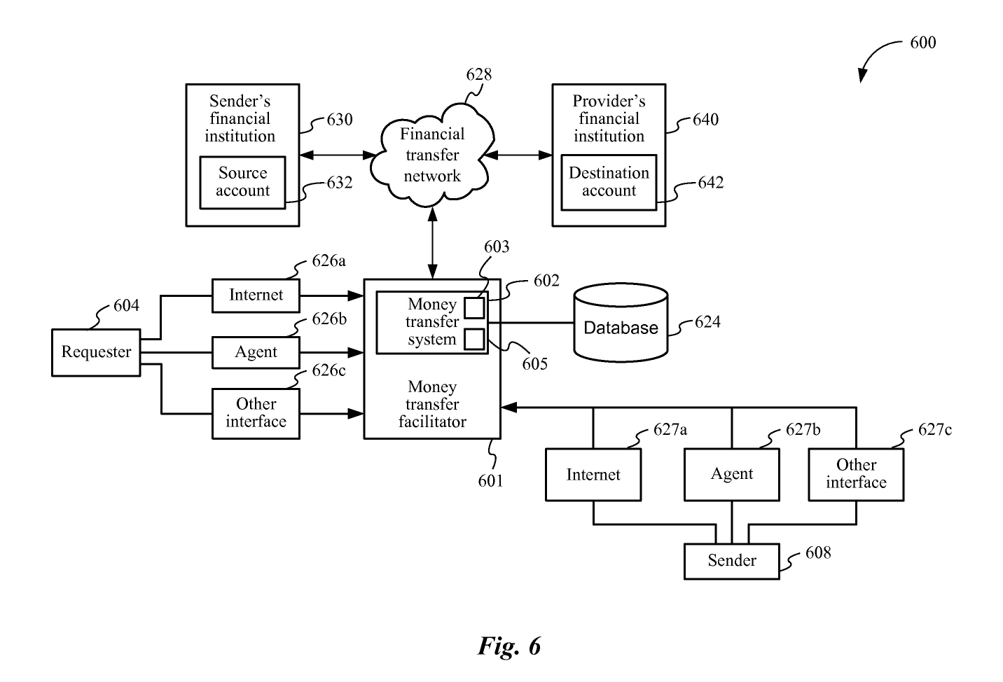

FIG. 6 depicts a block diagram illustrating a system 600 for restricting the disbursement of funds in a money transfer. The figure depicts a money transfer facilitator 601 that uses the money transfer system 602 to transfer funds from the sender to the provider in accordance with the various embodiments of the invention. The money transfer facilitator can be any type of financial institution or money transfer institution. In addition, the money transfer system can be a software application that the money transfer facilitator uses or may be configured as a hardware device. The money transfer system can be configured so that any information communicated to the money transfer facilitator by the provider, the sender, or the requester is provided to the money transfer system. For example, the money transfer facilitator can be arranged so that the requester and/or sender can interact in person with an agent of the money transfer facilitator and information can be input into the money transfer system.

The money transfer facilitator 601 may be arranged to allow a requester 604 to communicate and/or interact with the money transfer system in person or through a variety of media and thereby send the money transfer request to the money transfer system. For example, as shown in FIG. 6, the requester 604 may communicate and/or interact with the money transfer system through the use of a communication device such as the Internet 626a, a mobile phone application (not shown), or any other interface device 626c, or the requester may interact in person through an agent 626b of the money transfer facilitator. Similarly, the money transfer facilitator may be arranged to allow a sender 608 to communicate and/or interact with the money transfer system in person or through a variety of media and thereby receive the money transfer request from the money transfer system and send the acceptance and/or any restrictions to the money transfer system. FIG. 6 shows the sender interacting with the money transfer facilitator through the use of the Internet 627a, in person through an agent 627b, and through any other interface 627c. Although not depicted in FIG. 6, the money transfer facilitator may be arranged to allow the provider to communicate and/or interact with the money transfer system in a similar manner. One skilled in the art will realize that numerous other methods may be used in which the requester and/or sender can communicate or interact with the money transfer facilitator. The money transfer system 602 may have a communication interface 605 that receives or obtains any information provided to the money transfer facilitator by the sender, the requester, or the provider. Specifically, the communication interface may be configured to receive the money transfer request from a communication device 626a-626c that the requester may use to send the money transfer request. The communication interface may be further configured to provide the money transfer request to the sender and/or the provider and to receive the sender's and/or the provider's acceptance to perform the money transfer along with any restrictions that the sender and/or provider may place on the money transfer as previously described.

The money transfer system 602 may communicate and/or interact with a database 624 to provide and receive information concerning the money transfer as previously described. For example, the money transfer system may communicate with the database to obtain information such as any restrictions, any account information, etc. In addition, as previously described, the database may be associated with and/or maintained by the money transfer facilitator and/or any other institution.

The money transfer facilitator 601 can interact with a financial transfer network 628 to execute the money transfer. Specifically, the money transfer system 602 may comprise a processor 603 that communicates with the financial transfer network 628 to execute the money transfer. The financial transfer network 628 may be in communication with the sender's financial institution 630, such as the sender's bank, that has a source account 632 where the sender's funds are kept. The financial transfer network 628 may further be in communication with the provider's financial institution 640, such as the provider's bank, that has a destination account 642 where the funds are to be transferred. When the money transfer is executed, the money transfer facilitator 601 may communicate with the financial transfer network 628 through the processor 603 of the money transfer system 602 to transfer the funds from the sender's source account 632 to the provider's destination account 642. For example, a processor 603 of the money transfer system 602 may send a message to the financial transfer network 628 signaling the financial transfer network to transfer the funds from the source account 632 to the destination account 642; the message may also include any restrictions that are placed on the money transfer by the sender or the provider as previously described. Alternatively, the restrictions may be processed by the processor 603 before the message is sent to the financial transfer network so that the money transfer is executed in accordance with the restrictions, but the message does not include the restrictions. The processor 603 may also be used to calculate any fees that the money transfer facilitator may charge for the money transfer service. The fees may be constant or variable as previously described and the processor may further apply the fees to the money transfer as previously described.

By way of brief illustration and without limitation, the system 600 may be used in following manner. The requester 604 may send a money transfer request to the money transfer system 602 using any of the methods shown in blocks 626 that are communicatively coupled with the money transfer facilitator 601. The money transfer system 602 may then send the money transfer request to the sender 608 and provider (not shown) using any of the methods shown in blocks 627 that are likewise communicatively coupled with the money transfer facilitator 601. Upon receiving an acceptance and any restrictions from the sender 608 and, optionally, the provider (not shown) and after communicating with any database 624, the money transfer system 602 may then send a message to the financial transfer network 628 signaling the financial transfer network to execute a money transfer whereby funds are debited from the sender's source account 632 maintained at the sender's financial institution 630 and credited to the provider's destination account 642 maintained at the provider's financial institution 640. Additionally, the message sent to the financial transfer network may optionally include, but need not include, the sender's and provider's restrictions on the money transfer.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of restricting the disbursement of funds in a money transfer, the method comprising:
receiving, by a money transfer system, a money transfer request from a requester, the money transfer request including information about a pending transaction between the requester and a provider;
providing, by the money transfer system, the money transfer request to a sender, wherein the money transfer request informs the sender of the pending transaction and requests that the sender provide funds for the pending transaction;
receiving, by the money transfer system, an acceptance from the sender to perform the money transfer, wherein the money transfer provides funds for the pending transaction, and wherein the acceptance restricts the use of the funds of the money transfer to payment of the pending transaction; and
executing, by the money transfer system, a money transfer from the sender to the provider such that the money is transferred from the sender to the provider without being accessible to the requester.

2. The method of restricting the disbursement of funds in a money transfer as in claim 1, the method further comprising:
sending, by the money transfer system, a transaction identifier to the sender, wherein the transaction identifier associates the money transfer with the provider.

3. The method of restricting the disbursement of funds in a money transfer as in claim 2, the method further comprising:
receiving, by the money transfer system, the transaction identifier from the provider, wherein the sender provides the transaction identifier to the provider, and wherein the transaction identifier allows the provider to gain control of the funds.

4. The method of restricting the disbursement of funds in a money transfer as in claim 1, the method further comprising:
calculating, by the money transfer system, a fee associated with the money transfer, wherein the fee depends on one or more of the following: the amount of funds transferred in the money transfer, currency conversion, transfer restrictions that are applied to the money transfer, the location that the money transfer is initiated, and the location that the money transfer is completed.

5. The method of restricting the disbursement of funds in a money transfer as in claim 4, wherein the fee is applied to the money transfer by the money transfer system before the money transfer is executed, the fee being used to pay for the money transfer service.

6. The method of restricting the disbursement of funds in a money transfer as in claim 1, the method further comprising:
receiving, by the money transfer system, a restriction from the sender along with the acceptance, wherein the restriction restricts the use of the funds to pay for the pending transaction, and wherein the restriction further restricts the requester's ability to exchange a product for value, the product being the part of the pending transaction that the funds paid for and the value being one or more of the following: money, an additional product, and a service.

7. The method of restricting the disbursement of funds in a money transfer as in claim 6, wherein the restriction directs that the funds be transferred from the provider back to the sender upon the requester attempting to exchange the product for value.

8. The method of restricting the disbursement of funds in a money transfer as in claim 1, wherein the pending transaction includes an invoice for a product and/or a service, and wherein the money transfer request provides the sender with information about the invoice for the product and/or the service and how the funds are to be applied to the invoice thereby facilitating the sender in deciding whether to accept to provide the funds in the money transfer.

9. The method of restricting the disbursement of funds in a money transfer as in claim 8, wherein the money transfer request is received by the money transfer system in one of the following ways:
a money transfer application made over the Internet;
a photograph of the product and/or the service taken from a mobile device, wherein the photograph is sent to the money transfer system along with a message requesting that the sender provide funds to pay for the product and/or the service in the photograph;
a photograph of the product and/or the service taken from a camera, wherein the photograph is sent to the money transfer system along with a message requesting that the sender provide funds to pay for the product and/or the service in the photograph; and
the request made in person by the requester to an agent using the money transfer system, wherein the requester provides the agent with the information about the pending transaction including information about the product and/or the service, and wherein the requester further provides the agent with the request that the sender provide funds for the pending transaction, and wherein the agent provides the information and the request to the money transfer system.

10. A method of restricting the disbursement of funds in a money transfer, the method comprising:
receiving, by a money transfer system, a money transfer request from a requester, wherein the money transfer request comprises information about a pending transaction between the requester and a provider;
providing, by the money transfer system, the money transfer request to a sender, wherein the money transfer request informs the sender of the pending transaction and requests that the sender provide funds for the pending transaction;
receiving, by the money transfer system, an acceptance from the sender to perform the money transfer, wherein the money transfer provides funds for the pending transaction, and wherein the acceptance restricts the use of the funds of the money transfer to payment of the pending transaction;
sending, by the money transfer system, a transaction identifier to the sender, wherein the transaction identifier associates the money transfer with the provider;
executing, by the money transfer system, a money transfer from the sender to the provider, wherein the transaction identifier is received by the money transfer system from the provider, and wherein the money transfer occurs such that the money is transferred from the sender to the provider without being accessible to the requester.

11. The method of restricting the disbursement of funds in a money transfer as in claim 10, the method further comprising:
calculating, by the money transfer system, a fee associated with the money transfer, wherein the fee depends on any or all of the following: the amount of funds transferred in the money transfer, any currency conversion, any transfer restrictions that are applied to the money transfer, the location that the money transfer is initiated, and the location that the money transfer is completed.

12. The method of restricting the disbursement of funds in a money transfer as in claim 11, wherein the fee is applied to the money transfer by the money transfer system before the money transfer is executed, the fee being used to pay for the money transfer service.

13. The method of restricting the disbursement of funds in a money transfer as in claim 10, the method further comprising:
receiving, by the money transfer system, a restriction from the sender along with the acceptance, wherein the restriction restricts the use of the funds to pay for the pending transaction, and wherein the restriction further restricts the requester's ability to exchange a product for value, the product being the part of the pending transaction that the funds paid for and the value being any of the following: money, an additional product, a service, or any combination thereof.

14. The method of restricting the disbursement of funds in a money transfer as in claim 13, wherein the restriction directs that the funds be transferred from the provider back to the sender upon the requester attempting to exchange the product for value.

15. The method of restricting the disbursement of funds in a money transfer as in claim 10, wherein the pending transaction includes an invoice for a product and/or a service, and wherein the money transfer request provides the sender with information about the invoice for the product and/or the service and how the funds are to be applied to the invoice thereby facilitating the sender in deciding whether to accept to provide the funds in the money transfer.

16. The method of restricting the disbursement of funds in a money transfer as in claim 15, wherein the money transfer request is received by the money transfer system in one of the following ways:
a money transfer application made over the Internet;
a photograph of the product and/or the service taken from a mobile device, wherein the photograph is sent to the money transfer system along with a message requesting that the sender provide funds to pay for the product and/or the service in the photograph;
a photograph of the product and/or the service taken from a camera, wherein the photograph is sent to the money transfer system along with a message requesting that the sender provide funds to pay for the product and/or the service in the photograph;
and the request made in person by the requester to an agent using the money transfer system, wherein the requester provides the agent with the information about the pending transaction including information about the product and/or the service and wherein the requester further provides the agent with the request that the sender provide funds for the pending transaction, and wherein the agent provides the information and the request to the money transfer system.

17. A system for restricting the disbursement of funds in a money transfer process, the system comprising:
a communication device, the communication device being used by a requester to send a money transfer request, wherein the money transfer request comprises information about a pending transaction between the requester and a provider; and
a money transfer system in communication with the communication device, the money transfer system comprising a communication interface and a processor:
wherein, the communication interface is configured to:
receive the money transfer request from the communication device,
provide the money transfer request to the sender, wherein the money transfer request informs the sender of the pending transaction and requests that the sender provide funds for the pending transaction,
receive an acceptance from the sender to perform the money transfer, wherein the money transfer provides funds for the pending transaction, and wherein the acceptance restricts the use of the funds of the money transfer for payment of the pending transaction,
and wherein, the processor is configured to execute the money transfer from the sender to the provider such that the money is transferred from the sender to the provider without being accessible to the requester.

18. The system for restricting the disbursement of funds in a money transfer process as in claim 17, wherein the processor is further configured to calculate a fee associated with the money transfer, wherein the fee depends on any or all of the following: the amount of funds transferred in the money transfer, any currency conversion, any transfer restrictions that are applied to the money transfer, the location that the money transfer is initiated, and the location that the money transfer is completed.

19. The system for restricting the disbursement of funds in a money transfer process as in claim 17, wherein the communication interface is further configured to receive a restriction from the sender along with the acceptance, wherein the restriction restricts the use of the funds to pay for the pending transaction, and wherein the restriction further restricts the requester's ability to exchange a product for value, the product being a part of the pending transaction that the funds paid for and the value being one or more of the following: money, an additional product, and a service.

20. The system for restricting the disbursement of funds in a money transfer process as in claim 19, wherein the restriction directs that the funds be transferred from the provider back to the sender upon the requester attempting to exchange the product for value.
